(19) United States
(12) Patent Application Publication
(10) Pub. No.: US 2018/0347403 A1
(43) Pub. Date: Dec. 6, 2018

(54) TURBINE ENGINE WITH UNDULATING PROFILE

(71) Applicant: General Electric Company, Schenectady, NY (US)

(72) Inventors: Mahendran Manoharan, Karnataka (IN); Ganesh Seshadri, Karnataka (IN); Robert J. Beacock, Cincinatti, OH (US); Lyle Douglas Dailey, Maineville, OH (US); Ravikanth Avancha, Karnataka (IN)

(21) Appl. No.: 15/609,368

(22) Filed: May 31, 2017

(51) Int. Cl. F01D 25/26; F02C 3/04; F01D 9/04; F01D 5/02

(52) U.S. Cl. CPC F01D 25/26; F02C 3/04; F05D 2250/611; F01D 5/02; F01D 9/041

(57) ABSTRACT

An apparatus and method for a turbine engine comprising an outer casing having a first surface and defining an axial centerline and an inner casing located within the outer casing and having a second surface spaced. The first and second surfaces are spaced from each other and define an annular channel between where a combustion air flows in a fore to aft direction along a profile.

### BACKGROUND OF THE INVENTION

Turbine engines, and particularly gas or combustion turbine engines, are rotary engines that extract energy from a flow of combusted gases passing through the engine onto a multitude of rotating turbine blades.

The cycle of the turbine engine can include intake of air in an inlet section, compression of air in a compressor section, combustion of air with fuel injected in a combustion section, and finally expansion and exhaust of the air in a turbine section. Generally, the inlet and compressor section become increasingly convergent leading to the combustion section and the turbine section is increasingly divergent. This enables appropriate pressurization of the air flowing to and through the combustion section and a general decreasing of pressure as the air flows out of the turbine section.

The turbine section can include turbine stages where local pressure differences can cause leakage around consecutive stages. To maximize efficiency in the turbine section, air should pass through the intended gas path through each of the turbine stages and leakage around the stages should be minimized.

### BRIEF DESCRIPTION OF THE INVENTION

In one aspect, the present disclosure relates to a turbine engine comprising an outer casing having a first surface and defining an axial centerline and an inner casing located within the outer casing and having a second surface spaced from the first surface to define an annular channel between the first and second surfaces. Combustion air flows through the annular channel in a forward to aft direction wherein one of the first or second surfaces has an undulating profile.

In another aspect, the present disclosure relates to a turbine engine comprising a turbine section with at least one turbine stage having a stationary vane assembly and a rotating blade assembly, and combustion air flows through the turbine stage in a forward to aft direction. The turbine engine further includes an outer casing surrounding the at least one turbine stage and having a first surface defining an axial centerline, an inner casing defining an annular channel and having a second surface, and the at least one turbine stage is located between the outer casing and the inner casing, and an undulating profile provided on one of the first or second surfaces.

In yet another aspect, the present disclosure relates to a method of changing static pressure within a turbine engine having an inner and outer casing that together define an annular channel where combustion air flows through the annulus in a forward to aft direction the method comprising undulating a surface coupled to one of the inner or outer casings to define an undulating profile, alternatingly increasing/decreasing a cross-sectional area of the annular channel, and alternatingly increasing/decreasing a local static pressure within the annular channel.

### BRIEF DESCRIPTION OF THE DRAWINGS

In the drawings:

FIG. 1 is a schematic cross-sectional diagram of a turbine engine for an aircraft.

FIG. 2 is an enlarged view of a low pressure turbine section of the turbine engine from FIG. 1 with an undulating profile in phantom.

FIG. 3 is an enlarged view of two stages of the low pressure turbine section of FIG. 2 with an undulating profile on a first surface.

FIG. 4 is an enlarged view of two stages of the low pressure turbine section of FIG. 2 with an undulating profile on a second surface.

FIG. 5 is an enlarged view of two stages of the low pressure turbine section of FIG. 2 with an undulating profile on the first and second surfaces.

### DETAILED DESCRIPTION OF THE INVENTION

Aspects of the disclosure described herein are directed to an undulating profile on a first, second, or both surfaces within a turbine section of a turbine engine. For purposes of illustration, the present disclosure will be described with respect to the low pressure turbine section for an aircraft gas turbine engine. It will be understood, however, that aspects of the disclosure described herein are not so limited and may have general applicability within an engine, including compressors, as well as in non-aircraft applications, such as other mobile applications and non-mobile industrial, commercial, and residential applications.

As used herein, the term “forward” or “upstream” refers to moving in a direction toward the engine inlet, or a component being relatively closer to the engine inlet as compared to another component. The term “aft” or “downstream” used in conjunction with “forward” or “upstream” refers to a direction toward the rear or outlet of the engine or being relatively closer to the engine outlet as compared to another component.

Additionally, as used herein, the terms “radial” or “radially” refer to a dimension extending between a center longitudinal axis of the engine and an outer engine circumference.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present disclosure, and do not create limitations, particularly as to the position, orientation, or use of aspects of the disclosure described herein. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

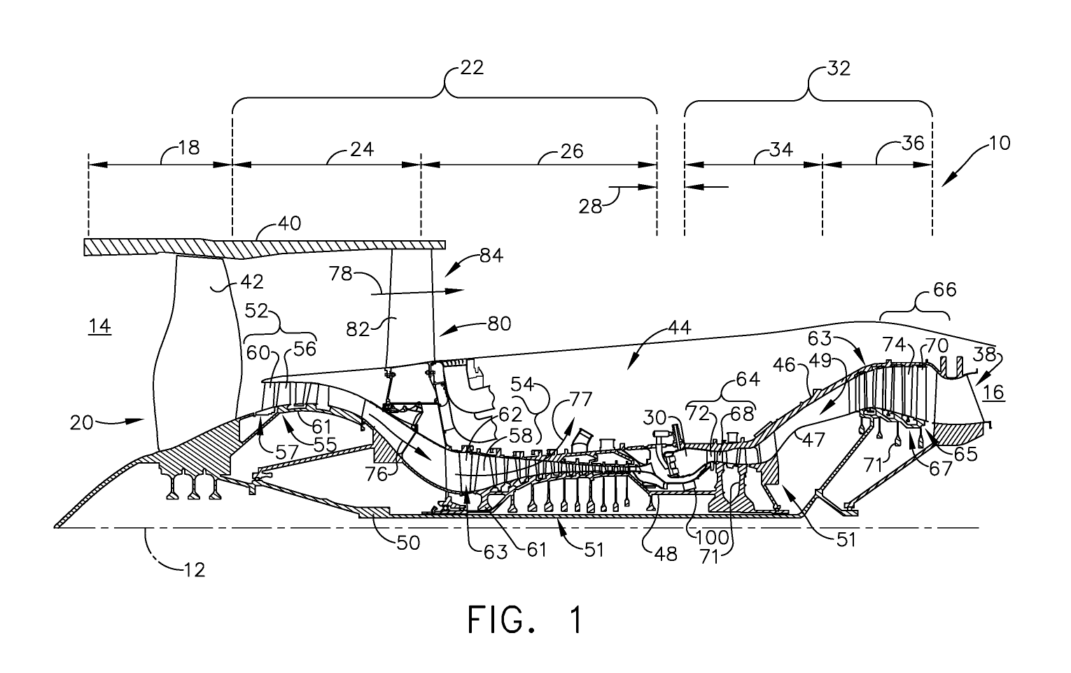

FIG. 1 is a schematic cross-sectional diagram of a turbine engine 10 for an aircraft. The engine 10 has a generally longitudinally extending axis or centerline 12 extending forward 14 to aft 16. The engine 10 includes, in downstream serial flow relationship, a fan section 18 including a fan 20, a compressor section 22 including a booster or low pressure (LP) compressor 24 and a high pressure (HP) compressor 26, a combustion section 28 including a combustor 30, a turbine section 32 including a HP turbine 34, and a LP turbine 36, and an exhaust section 38.

The fan section 18 includes a fan casing 40 surrounding the fan 20. The fan 20 includes a plurality of fan blades 42 disposed radially about the centerline 12. The HP compressor 26, the combustor 30, and the HP turbine 34 form a core 44 of the engine 10, which generates combustion gases. The core 44 is surrounded by outer casing 46, which can be coupled with the fan casing 40. An inner casing 47 is located within the outer casing 46 and together the inner casing 47 and outer casing 46 define an annular channel 49 through which the combustion gases can flow.

A HP shaft or spool 48 disposed coaxially about the centerline 12 of the engine 10 drivingly connects the HP turbine 34 to the HP compressor 26. A LP shaft or spool 50, which is disposed coaxially about the centerline 12 of the engine 10 within the larger diameter annular HP spool 48, drivingly connects the LP turbine 36 to the LP compressor 24 and fan 20. The spools 48, 50 are rotatable about the engine centerline and couple to a plurality of rotatable elements, which can collectively define a rotor 51.

The LP compressor 24 and the HP compressor 26 respectively include a plurality of compressor stages 52, 54 having a blade assemblies 55 and a vane assemblies 57. Each blade assembly 55 includes a set of compressor blades 56, 58 that rotate relative to each vane assembly 57 having a corresponding set of static compressor vanes 60, 62 (also called a nozzle) to compress or pressurize the stream of fluid passing through the stage. In a single compressor stage 52, 54, multiple compressor blades 56, 58 can be provided in a ring and can extend radially outwardly relative to the centerline 12, from a blade platform to a blade tip, while the corresponding static compressor vanes 60, 62 are positioned upstream of and adjacent to the rotating blades 56, 58. It is noted that the number of blades, vanes, and compressor stages shown in FIG. 1 were selected for illustrative purposes only, and that other numbers are possible.

The blades 56, 58 for a stage of the compressor can be mounted to a disk 61, which is mounted to the corresponding one of the HP and LP spools 48, 50, with each stage having its own disk 61. The vanes 60, 62 for a stage of the compressor can be mounted to the outer casing 46 in a circumferential arrangement.

The HP turbine 34 and the LP turbine 36 respectively include a plurality of turbine stages 64, 66, having blade assemblies 65 and a vane assemblies 67. Each blade assembly 65 includes a set of turbine blades 68, 70 that rotate relative to each vane assembly 67 having a corresponding set of static turbine vanes 72, 74 (also called a nozzle) to extract energy from the stream of fluid passing through the stage. In a single turbine stage 64, 66, multiple turbine blades 68, 70 can be provided in a ring and can extend radially outwardly relative to the centerline 12, from a blade platform to a blade tip, while the corresponding static turbine vanes 72, 74 are positioned upstream of and adjacent to the rotating blades 68, 70. It is noted that the number of blades, vanes, and turbine stages shown in FIG. 1 were selected for illustrative purposes only, and that other numbers are possible.

The blades 68, 70 for a stage of the turbine can be mounted to a disk 71, which is mounted to the corresponding one of the HP and LP spools 48, 50, with each stage having a dedicated disk 71. The vanes 72, 74 for a stage of the turbine can be mounted to the outer casing 46 in a circumferential arrangement.

Complementary to the rotor portion, the stationary portions of the engine 10, such as the static vanes 60, 62, 72, 74 among the compressor and turbine section 22, 32 are also referred to individually or collectively as a stator 63. As such, the stator 63 can refer to the combination of non-rotating elements throughout the engine 10.

In operation, the airflow exiting the fan section 18 is split such that a portion of the airflow is channeled into the LP compressor 24, which then supplies pressurized air 76 to the HP compressor 26, which further pressurizes the air. The pressurized air 76 from the HP compressor 26 is mixed with fuel in the combustor 30 and ignited, thereby generating combustion gases. Some work is extracted from these gases by the HP turbine 34, which drives the HP compressor 26. The combustion gases are discharged into the LP turbine 36, which extracts additional work to drive the LP compressor 24, and the exhaust gas is ultimately discharged from the engine 10 via the exhaust section 38. The driving of the LP turbine 36 drives the LP spool 50 to rotate the fan 20 and the LP compressor 24.

A portion of the pressurized airflow 76 can be drawn from the compressor section 22 as bleed air 77. The bleed air 77 can be drawn from the pressurized airflow 76 and provided to engine components requiring cooling. The temperature of pressurized airflow 76 entering the combustor 30 is significantly increased. As such, cooling provided by the bleed air 77 is necessary for operating of such engine components in the heightened temperature environments.

A remaining portion of the airflow 78 bypasses the LP compressor 24 and engine core 44 and exits the engine assembly 10 through a stationary vane row, and more particularly an outlet guide vane assembly 80, comprising a plurality of airfoil guide vanes 82, at the fan exhaust side 84. More specifically, a circumferential row of radially extending airfoil guide vanes 82 are utilized adjacent the fan section 18 to exert some directional control of the airflow 78.

Some of the air supplied by the fan 20 can bypass the engine core 44 and be used for cooling of portions, especially hot portions, of the engine 10, and/or used to cool or power other aspects of the aircraft. In the context of a turbine engine, the hot portions of the engine are normally downstream of the combustor 30, especially the turbine section 32, with the HP turbine 34 being the hottest portion as it is directly downstream of the combustion section 28. Other sources of cooling fluid can be, but are not limited to, fluid discharged from the LP compressor 24 or the HP compressor 26.

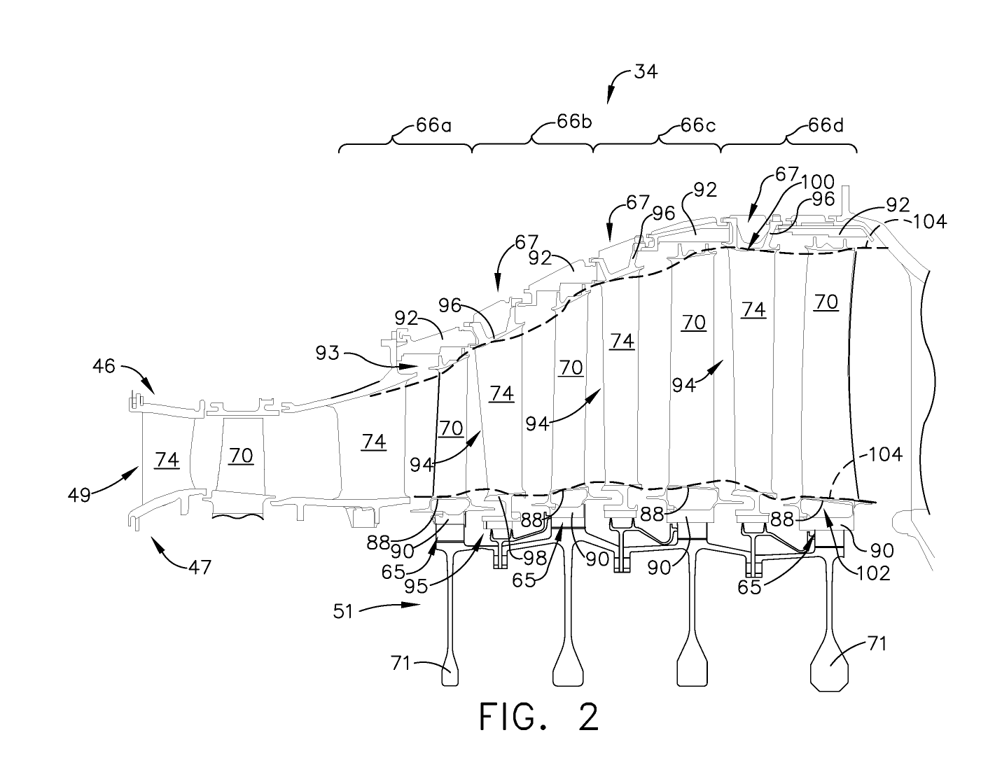

FIG. 2 is an enlarged view of a cross-section taken from FIG. 1 more clearly illustrating half of the annular channel 49 at the LP turbine 36. The LP turbine 36 can include multiple turbine stages 66. Each turbine stage 66 can include the blade and vane assemblies 65, 67. The blade and vane assemblies 65, 67 are provided within the annular channel 49 such that the consecutive blade and vane assemblies 65, 67 fill the annular channel 49 with circumferentially arranged blades 70 and vanes 74 through which the flow of combustion gases can move. It should be understood that while an LP turbine 36 is illustrated, aspects of the disclosure discussed herein are not limited to the LP turbine 36 and can be applied to other areas of the engine including to the compressor section 22 and the HP turbine 34.

The blade assemblies 65 can each include the blades 70 mounted to a blade platform 88 and extending radially out from dovetails 90. The dovetails 90 are mounted to the disk 71 and form the rotor 51. A plurality of circumferentially arranged shroud segments 92 surround the blades 70 to define a tip seal 93. A blade rim seal, or rim seal 95 is formed along the rotor 51 between alternating blade disks 71.

The vane assemblies 67 include an annular arrangement of vanes 74 that form nozzles 94. Circumferentially arranged hangers 96 are mounted to the outer casing 46. The vanes 74 extend radially inward toward the inner casing 47 and each mount to a vane platform 98 radially inward from the rotor 51.

Alternating shroud segments 92 and hangers 96 are mounted to the outer casing 46 together forming a first surface 100. The inner casing 47 is defined by alternating blade platforms 88 and vane platforms 98 together forming a second surface 102. An undulating profile 104 illustrated in dashed lines can be formed on at least one of the first or second surfaces 100, 102. It is further contemplated that the undulating profile 104 is formed on both the first and second surfaces 100, 102.

The LP turbine 36 includes stages 66a, 66b, 66c, and 66d. It should be understood that the LP turbine 36 can have more or less stages than illustrated, and that the stages are for illustrative purposes only.

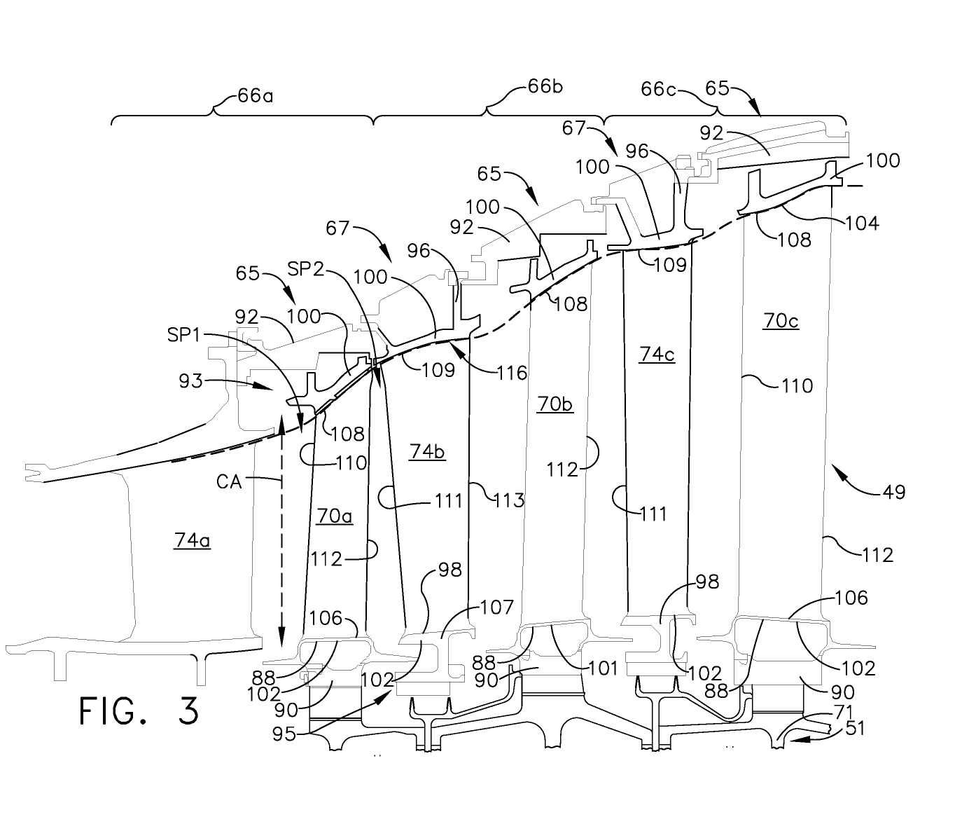

Turning to FIG. 3, stages 66a and 66b are enlarged to more clearly illustrate a first exemplary undulating profile 104 formed on the first surface 100. For illustrative purposes turbine stage 66a is a first stage having a first vane 74a and first blade 70a and turbine stage 66b is a second stage having a second vane 74b and second blade 70b.

A cross-sectional area (CA) of the annular channel 49 has an overall increase in size moving in a forward to aft direction. Within each individual turbine stage 66a, 66b, and 66c it can be seen that the cross-sectional area (CA) of the annular channel 49 alternatingly increases/decreases due to a local increase or decrease of the vane 74 and or blade 70 structure at the first surface 100. For example, the first blade 70a extends from the blade platform 88 at a root 106 to a tip 108 radially inward of the shroud segments 92. The tip 108 is shaped such that the cross-sectional area (CA) of the annular channel 49 has a local increase in a forward to aft direction across the first blade 70a. A leading edge 110 of the first blade 70a is therefore shorter than a trailing edge 112 of the first blade 70a resulting in the local cross-sectional area (CA) being smaller at the leading edge 110 than the trailing edge 112.

The second vane 74b is formed such that a local decrease in the cross-sectional area (CA) occurs between a leading edge 111 of the second vane 74b and a trailing edge 113 of the second vane 74b. While the trailing edge 113 of the second vane 74b is equal to or longer than the leading edge 111 of the second vane 74b, it can be noted that at a middle point along a tip 109 of the second vane 74b, the local cross-sectional area (CA) increases and then decreases in a forward to aft direction across the tip 109 of the first blade 74a. This pattern continues along the first surface 100 to define the undulating profile 104.

It is contemplated that the local increases and decreases of the cross-sectional area (CA) can be formed from structural changes at the first surface 100 in different ways. The undulating profile 104 is also defined at least in part by non-uniform or dis-continuous slopes 116 at the first surface 100. By way of non-limiting example, the second blade 70b is formed much like the first blade 70a, while a third vane 74c maintains an even profile at the tip 109, which causes an overall decrease in the undulating profile 104 with respect to the surrounding blades 70.

The local decrease in cross-sectional area (CA) at the leading edge 110 of the first blade 70a causes a local decrease in static pressure proximate to the outer casing 46 within the annular channel 49. The local increase in cross-sectional area (CA) across the first blade 70a causes a local increase in a static pressure (SP2) at the trailing edge 112 of the first blade 70a and a local decrease in a static pressure (SP1) at the leading edge 110 of the first blade 70a. As a result, a static pressure delta (SP2-SP1) across the outer casing 46 tip seal 93 of the blade 70a between the leading edge 110 and trailing edge 112 of the first blade 70a is minimized. This reduces the leakage flows across the tip seal 93 in the first surface leading to less turbine aerodynamic losses.

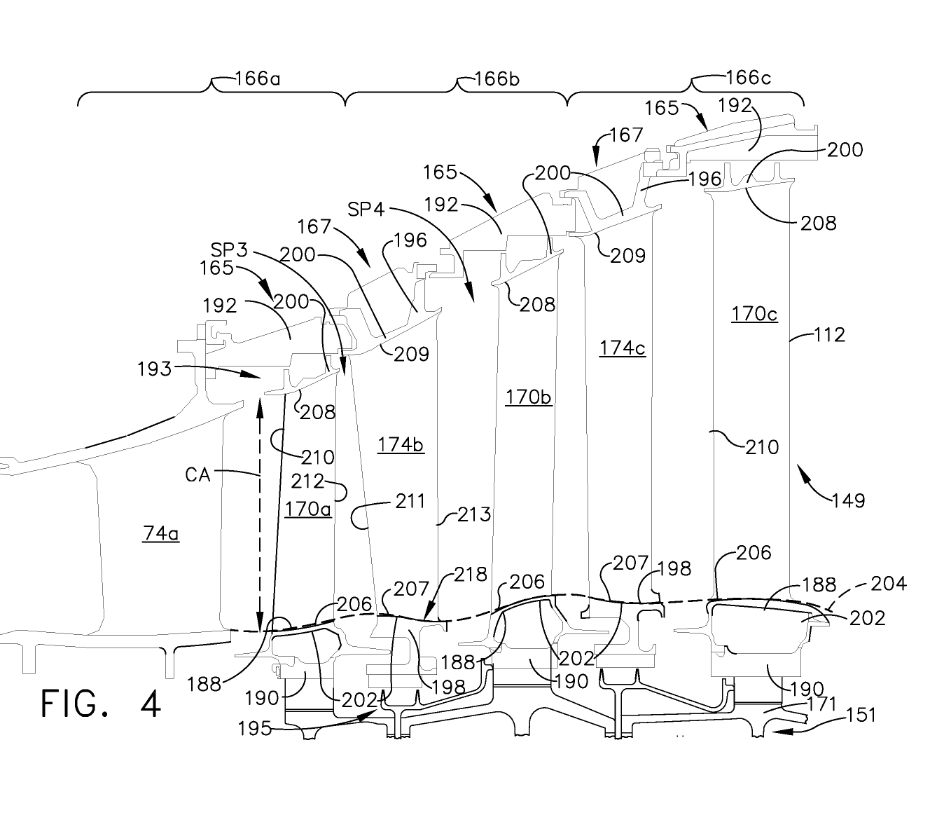

Turning to FIG. 4, a second exemplary undulating profile 204 is contemplated on a second surface 202. The first exemplary undulating profile 104 is like the second exemplary undulating profile 204. Therefore, like parts will be identified with like numerals increased by 100, with it being understood that the description of the like parts of the first exemplary undulating profile 104 applies to the second exemplary undulating profile 204, unless otherwise noted.

Similar to the first exemplary undulating profile 104, a cross-sectional area (CA) of an annular channel 149 has an overall increase in size moving in a forward to aft direction while local cross-sectional areas alternatingly increase/decrease. For the undulating profile 204 located on the second surface 202, a second vane 174b includes a vane platform 198 shaped to reduce the length of a leading edge 211 of the second vane 174b such that a local decrease in the cross-sectional area (CA) occurs between the first blade 170a and the second vane 174b. Similarly the undulating profile 204 is shaped in such a way that the local cross-sectional area (CA) aft of the second vane 174a increases. The undulating profile 204 is also defined at least in part by non-uniform or dis-continuous slopes 218 at the second surface 202. This pattern continues along the second surface 202 to define the undulating profile 204.

The undulating profile 204 causes a decrease in a local static pressure (SP3) forward of the second vane 174b leading edge 211 and increase in a local static pressure (SP4) aft of the second vane 174b trailing edge 213. This minimizes a static pressure delta (SP4-SP3) across the rim seal 195 occuring between the second vane 174b leading edge 211 and trailing edge 213. The reduced static pressure delta (SP4-SP3) minimizes the leakage flow across the rim seal 195 leading to less turbine aerodynamic losses.

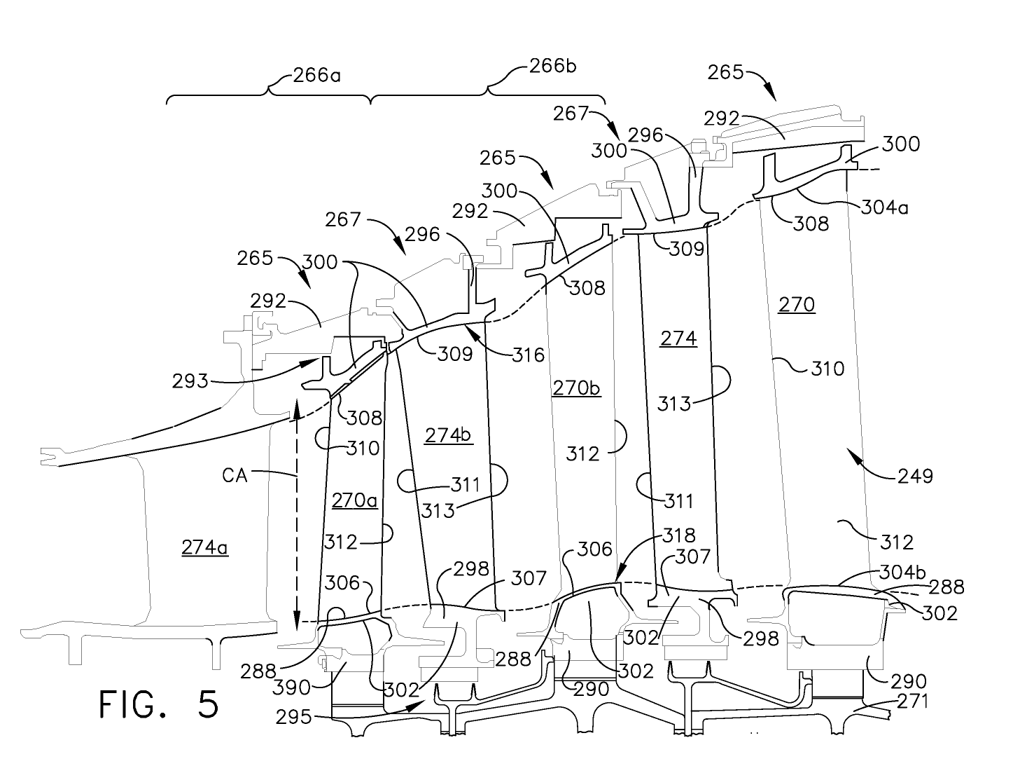

Turning to FIG. 5, a third exemplary undulating profile 304 is contemplated on a first surface 300 and a second surface 302. The first exemplary undulating profile 104 is like the third exemplary undulating profile 304 therefore, like parts will be identified with like numerals increased by 200, with it being understood that the description of the like parts of the first exemplary undulating profile 104 applies to the third exemplary undulating profile 304, unless otherwise noted.

The third exemplary undulating profile is two undulating profiles 304a, 304b, simply a combination of the first and second exemplary undulating profiles 104, 204. Both first and second surfaces 300, 302 are shaped to form local alternating increases and decreases in a cross-sectional area (CA) of the annular channel 49. In combining the undulating profiles 104, 204 as described herein, larger increases and decreases in the cross-sectional area (CA) are formed.

The local decreases in cross-sectional area (CA) cause local decreases in static pressure within the annular channel 49. The local increases in cross-sectional area (CA) cause local increases in the static pressure within the annular channel 49. Depending on where the static pressure delta across the tip seal 93 and rim seal 195 within respective stages 66 needs to become minimized, forming of the first, second, or both surfaces 100, 200, 300, 102, 202, 302 as described herein can be implemented. The reduction in pressure delta across the tip seal 93 and rim seal 195 within consecutive stages minimizes leakage around the tip seals 93 of consecutive blades 70 and at the rim seal 95 between consecutive vanes 74 ensuring an even flow of exhaust gases through the nozzles 94 rather than around them.

A method of changing static pressure within a turbine engine as described herein includes undulating the first, second, or both surfaces coupled to one of the inner or outer casings to define an undulating profile. The method includes alternatingly increasing/decreasing a cross-sectional area of the annular channel and alternatingly increasing/decreasing a local static pressure within the annular channel. The decrease in the cross-sectional area corresponds to a decrease in the local static pressure and vice versa as described herein.

Traditionally low pressure turbines can experience turbine aerodynamic loss reduction in combustion gas flow through the blades and nozzles. Aspects of the disclosure discussed herein minimize leakages causing these turbine aerodynamic loss reductions by undulating the flow path along which the combustion gases flow. Varying the slopes of the surfaces between which vanes and blades extend helps to reduces mass flow leakage at the surfaces. An additional benefit is that varying the slopes, particularly those which cause a narrowing of the cross-sectional area increases the rate at which the gases flow through reducing secondary losses as well.

A reduction in the pressure differences between stages through the LP turbine also creates less sensitivity to clearance in terms of blade tip due to the equalizing of pressures. This can translate to maintenance and cost benefits. A more streamline flow path also improves the specific fuel consumption rate.

It should be appreciated that application of the disclosed design is not limited to turbine engines with fan and booster sections, but is applicable to turbojets and turbo engines as well.

This written description uses examples to describe aspects of the disclosure described herein, including the best mode, and also to enable any person skilled in the art to practice aspects of the disclosure, including making and using any devices or systems and performing any incorporated methods. The patentable scope of aspects of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A turbine engine comprising:
an outer casing having a first surface and defining an axial centerline; and
an inner casing located within the outer casing and having a second surface spaced from the first surface to define an annular channel between the first and second surfaces, and combustion air flows through the annular channel in a forward to aft direction;
wherein one of the first or second surfaces has an undulating profile.

2. The turbine engine of claim 1 wherein both first and second surfaces have the undulating profile.

3. The turbine engine of claim 1 wherein the annular channel has an overall increasing cross-sectional area.

4. The turbine engine of claim 3 wherein the cross-sectional area of the annular channel alternatingly increase/decreases.

5. The turbine engine of claim 4 wherein the undulating profile is defined at least in part by non-uniform slopes at the first and/or second surface.

6. The turbine engine of claim 5 wherein a static pressure within the annular channel increases when the annular channel increases and decreases when the annular channel decreases.

7. The turbine engine of claim 1 wherein the outer casing comprises a plurality of hangers and shroud segments together defining the first surface.

8. The turbine engine of claim 7 wherein the inner casing comprises a plurality of platforms together defining the second surface.

9. The turbine engine of claim 1 further including at least one stage comprising circumferentially arranged vanes and circumferentially arranged blades wherein the vanes and blades extend radially between a tip seal and a rim seal.

10. The turbine engine of claim 9 wherein a static pressure delta is reduced across the tip and/or rim seal proximate to the first and/or second surface between a leading edge of the circumferentially arranged blade and a trailing edge of the circumferentially arranged blade in the at least one stage.

11. A turbine engine comprising:
a turbine section with at least one turbine stage having a stationary vane assembly and a rotating blade assembly, and combustion air flows through the turbine stage in a forward to aft direction;
an outer casing surrounding the at least one turbine stage and having a first surface defining an axial centerline;
an inner casing defining an annular channel and having a second surface, and the at least one turbine stage is located between the outer casing and the inner casing; and
an undulating profile provided on one of the first or second surfaces.

12. The turbine engine of claim 11 wherein both first and second surfaces have the undulating profile.

13. The turbine engine of claim 12 wherein the annular channel has an overall increasing cross-sectional area.

14. The turbine engine of claim 13 wherein the cross-sectional area of the annular channel alternatingly increase/decreases.

15. The turbine engine of claim 14 wherein the undulating profile is defined at least in part by non-uniform slopes at the first and/or second surface.

16. The turbine engine of claim 15 wherein a static pressure within the annular channel increases when the annular channel increases and decreases when the annular channel decreases.

17. The turbine engine of claim 11 wherein the outer casing comprises a plurality of hangers and shroud segments together defining the first surface.

18. The turbine engine of claim 17 wherein the inner casing comprises a plurality of platforms and dovetails together defining the second surface.

19. The turbine engine of claim 11 further the at least one turbine stage extends between a tip seal and a rim seal.

20. The turbine engine of claim 19 wherein a static pressure delta is reduced across the tip and/or rim seal proximate to the first and/or second surface between the leading edge of the blade and trailing edge of the blade in the at least one turbine stage.

21. A method of changing static pressure within a turbine engine having an inner and outer casing that together define an annular channel where combustion air flows through the annulus in a forward to aft direction the method comprising:
undulating a surface coupled to one of the inner or outer casings to define an undulating profile;
alternatingly increasing/decreasing a cross-sectional area of the annular channel; and
alternatingly increasing/decreasing a local static pressure within the annular channel.

22. The method of claim 19 wherein a decrease in the cross-sectional area corresponds to a decrease in the local static pressure and vice versa.
